(19) United States
(12) Patent Application Publication
(10) Pub. No.: US 2025/0175893 A1
(43) Pub. Date: May 29, 2025

(54) COMMUNICATION CONTROL METHOD

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 19/037,791

(22) Filed: Jan. 27, 2025

Related U.S. Application Data
(63) Continuation of application No. PCT/JP2023/027046, filed on Jul. 24, 2023.

(30) Foreign Application Priority Data
Jul. 27, 2022 (JP) 2022-119418

(51) Int. Cl. H04W 48/18; H04W 36/00; H04W 36/08; H04W 68/02

(52) U.S. Cl. CPC H04W 48/18; H04W 36/0061; H04W 36/08; H04W 68/02

(57) ABSTRACT

A communication control method according to one aspect is a communication control method in a mobile communication system. The communication control method includes transmitting, by a core network device to a user equipment, Mobile Terminated (MT) slice information indicating network slices associated with paging.

### RELATED APPLICATIONS

The present application is a continuation based on PCT Application No. PCT/JP2023/027046, filed on Jul. 24, 2023, which claims the benefit of Japanese Patent Application No. 2022-119418 filed on Jul. 27, 2022. The content of which is incorporated by reference herein in their entirety.

### TECHNICAL FIELD

The present disclosure relates to a communication control method in mobile communication systems.

### BACKGROUND

Specifications of the Third Generation Partnership Project (3GPP) (registered trade name; the same applies hereinbelow) that is a standardization project for mobile communication systems define network slicing. Network slicing is a technique of logically dividing a physical network constructed by a telecommunications carrier to configure network slices that are virtual networks.

A user equipment in a Radio Resource Control (RRC) idle state or an RRC_INACTIVE state can perform a cell reselection procedure. The 3GPP has studied slice specific cell reselection (slice aware cell reselection or slice based cell reselection) that is a network slice-dependent cell reselection procedure (see, for example, Non-Patent Document 1). By performing the slice specific cell reselection procedure, a user equipment can camp on, for example, a neighboring cell that supports a desired network slice.

### CITATION LIST

### Non-Patent Literature

Non-Patent Document 1: 3GPP TS 38.300 V17.8.0 (2022-3)

### SUMMARY

A communication control method according to one aspect is a communication control method in a mobile communication system. The communication control method includes transmitting, by a core network device to a user equipment, Mobile Terminated (MT) slice information indicating a network slice associated with paging.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a User Equipment (UE) according to the first embodiment.

FIG. 3 is a diagram illustrating a configuration example of a gNB (base station) according to the first embodiment.

FIG. 4 is a diagram illustrating a configuration example of a protocol stack for a user plane according to the first embodiment.

FIG. 5 is a diagram illustrating a configuration example of a protocol stack for a control plane according to the first embodiment.

FIG. 6 is a diagram for explaining an overview of a cell reselection procedure.

FIG. 7 is a diagram illustrating a schematic flow of a typical cell reselection procedure.

FIG. 8 is a diagram illustrating an example of network slicing.

FIG. 9 is a diagram illustrating an overview of a slice specific cell reselection procedure.

FIG. 10 is a diagram illustrating an example of slice frequency information.

FIG. 11 is a diagram illustrating a basic flow of the slice specific cell reselection procedure.

FIG. 12 is a diagram illustrating an operation example according to the first embodiment.

FIGS. 13A and 13B are diagrams illustrating examples of relations between slices, slice priorities, and frequency priorities.

FIG. 14 is a diagram illustrating an operation example according to a second embodiment.

FIG. 15 is a diagram illustrating an operation example according to a third embodiment.

FIG. 16 is a diagram illustrating an operation example according to a fourth embodiment.

FIG. 17 is a diagram illustrating an operation example according to a fifth embodiment.

### DESCRIPTION OF EMBODIMENTS

The present disclosure enables a user equipment to connect to an appropriate cell.

A mobile communication system according to an embodiment will be described with reference to the drawings. In the description of the drawings, the same or similar parts are denoted by the same or similar reference signs.

### First Embodiment

### Configuration of Mobile Communication System

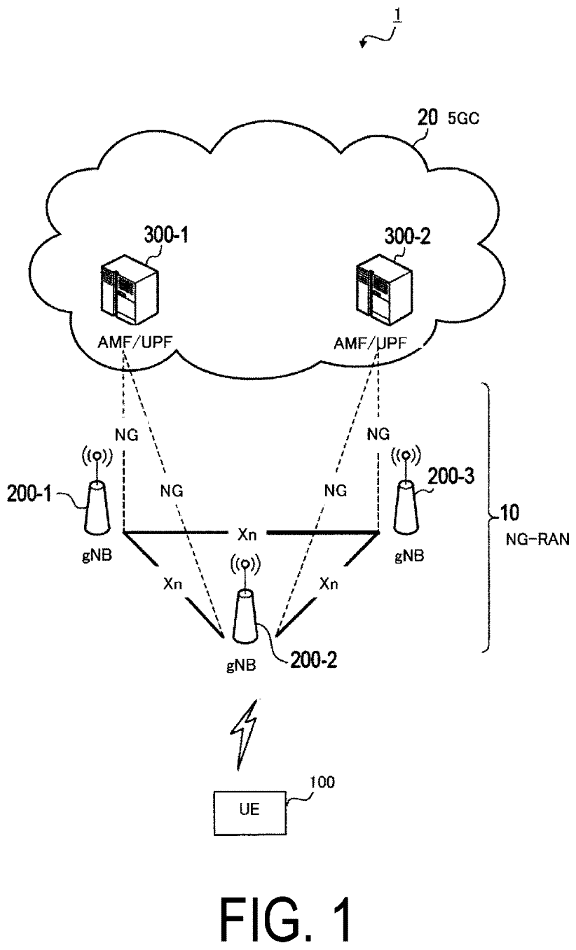

FIG. 1 is a diagram illustrating a configuration of the mobile communication system according to the first embodiment. A mobile communication system 1 complies with the 5th Generation System (5GS) of the 3GPP standards. The description below takes the 5GS as an example, but Long Term Evolution (LTE) system may be at least partially applied to the mobile communication system. The sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the Core Network (CN) 20.

The UE 100 is a mobile wireless communication device. The UE 100 may be any device as long as the UE 100 is used by a user. Examples of the UE 100 include a mobile phone terminal (including a smartphone) or a tablet terminal, a notebook PC, a communication module (including a communication card or a chipset), a sensor or a device provided on a sensor, a vehicle or a device provided on a vehicle (Vehicle UE), and a flying object or a device provided on a flying object (Aerial UE).

The NG-RAN 10 includes base stations (referred to as “gNBs” in the 5G system) 200. The gNBs 200 are interconnected via an Xn interface that is an inter-base station interface. Each gNB 200 manages one or more cells. The gNB 200 performs wireless communication with the UE 100 that has established connection to the cell of the gNB 200. The gNB 200 has a Radio Resource Management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can also be connected to an Evolved Packet Core (EPC) corresponding to a core network of LTE. An LTE base station can also be connected to the 5GC. The LTE base station and the gNB can also be connected via an inter-base station interface.

The 5GC 20 includes an Access and Mobility Management Function (AMF) and a User Plane Function (UPF) 300. The AMF performs various types of mobility controls and the like on the UE 100. The AMF manages mobility of the UE 100 by communicating with the UE 100 by using Non-Access Stratum (NAS) signaling. The UPF controls data transfer. The AMF and UPF are connected to the gNB 200 via an NG interface that is an interface between a base station and the core network.

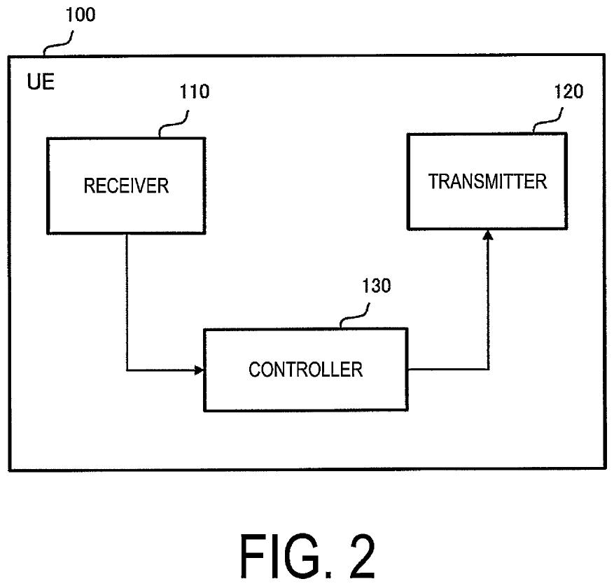

FIG. 2 is a diagram illustrating a configuration of the User Equipment (UE) 100 according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (reception signal) and outputs the baseband signal to the controller 130.

The transmitter 120 performs various types of transmission under control of the controller 130. The transmitter 120 includes an antenna and a transmission device. The transmission device converts a baseband signal (transmission signal) output by the controller 130 into a radio signal and transmits the radio signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to perform various types of processing. Note that the controller 130 may perform each processing and each operation in the UE 100 in each embodiment to be described below.

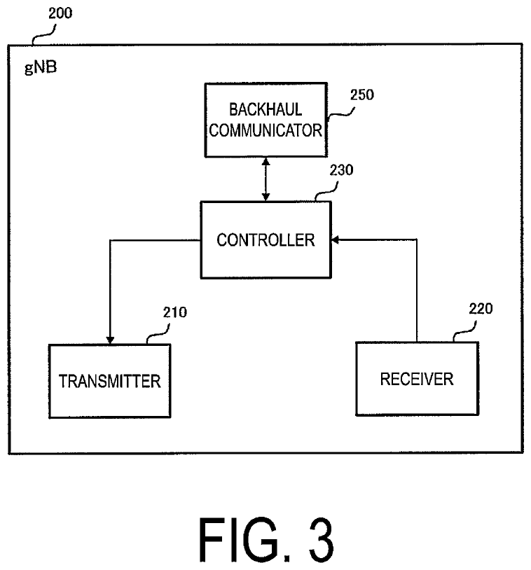

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (transmission signal) output by the controller 230 into a radio signal and transmits the radio signal through the antenna.

The receiver 220 performs various types of reception under control of the controller 230. The receiver 220 includes an antenna and a reception device. The reception device converts a radio signal received through the antenna into a baseband signal (reception signal) and outputs the baseband signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to perform various types of processing. Note that the controller 230 may perform all of the processing and operations in the gNB 200 in each embodiment to be described below.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both the units may be connected via an F1 interface that is a fronthaul interface.

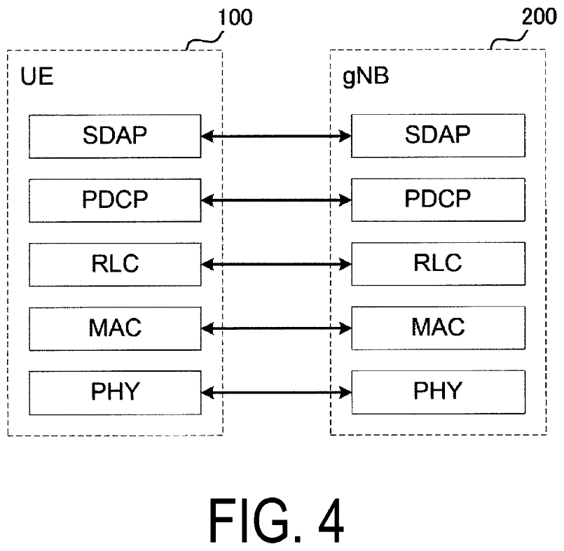

FIG. 4 is a diagram illustrating a configuration of a protocol stack of a radio interface of a user plane handling data.

A radio interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives Downlink Control Information (DCI) transmitted from the gNB 200 over a Physical Downlink Control CHannel (PDCCH). More specifically, the UE 100 blind decodes the PDCCH using a Radio Network Temporary Identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through Hybrid Automatic Repeat reQuest (HARQ: Hybrid ARQ), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

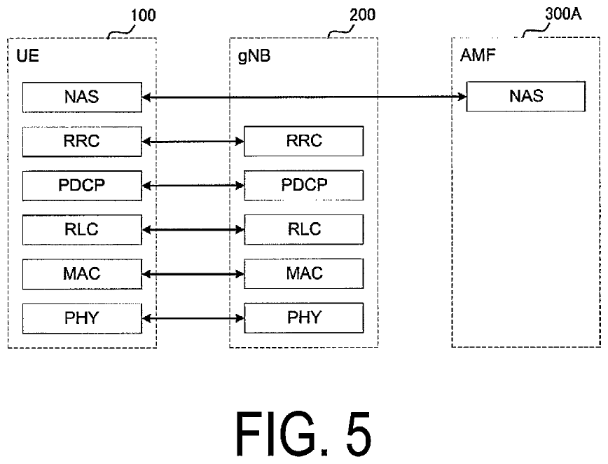

FIG. 5 is a diagram illustrating a configuration of a protocol stack of a radio interface of a control plane handling signaling (control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC_CONNECTED state. When no connection (RRC connection) between the RRC of the UE 100 and the RRC of the gNB 200 is present, the UE 100 is in an RRC_IDLE state. When the connection between the RRC of the UE 100 and the RRC of the gNB 200 is suspended, the UE 100 is in an RRC_INACTIVE state.

The NAS that is positioned upper than the RRC layer performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as an Access Stratum (AS).

### Overview of Cell Reselection Procedure

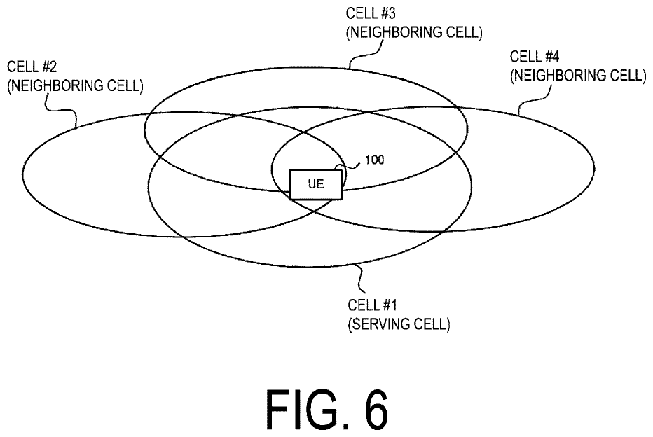

FIG. 6 is a diagram for illustrating an overview of a cell reselection procedure.

The UE 100 in the RRC_IDLE state or the RRC_INACTIVE state performs the cell reselection procedure to migrate from a current serving cell (cell #1) to a neighboring cell (any one of cells #2 to #4) as the UE 100 moves. More specifically, the UE 100 specifies a neighboring cell to which the UE needs to camp on through the cell reselection procedure, and reselects the specified neighboring cell. Frequencies (carrier frequencies) that are the same between the current serving cell and the neighboring cell will be referred to as intra-frequencies, and frequencies (carrier frequencies) that are different between the current serving cell and the neighboring cell will be referred to as inter-frequencies. The current serving cell and the neighboring cell may be managed by the same gNB 200. The current serving cell and the neighboring cell may be managed by the gNBs 200 different from each other.

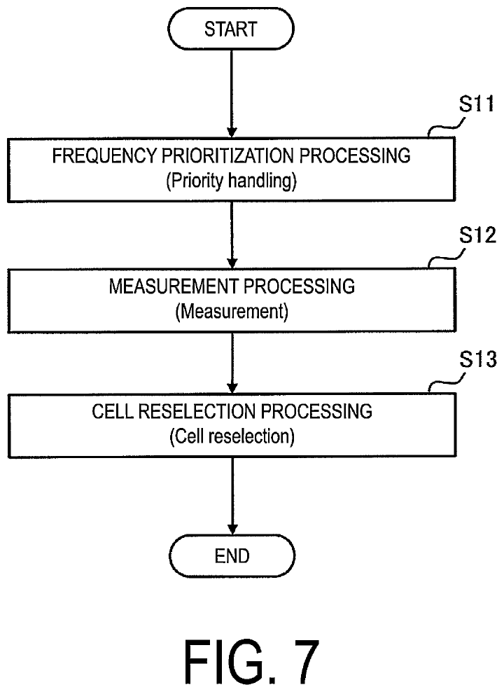

FIG. 7 is a flowchart indicating a schematic flow of a typical (or legacy) cell reselection procedure.

In step S11, the UE 100 performs frequency priority handling processing based on frequency-specific priorities (also referred to as “absolute priorities”) specified by the gNB 200 by way of, for example, a system information block or an RRC release message. More specifically, the UE 100 manages the frequency priority designated by the gNB 200 per frequency.

In step S12, the UE 100 performs measurement processing of measuring radio qualities of the serving cell and each of the neighboring cells. The UE 100 measures reception powers and reception qualities of reference signals transmitted by the serving cell and each of the neighboring cells, more specifically, a Cell Defining-Synchronization Signal and PBCH block (CD-SSB). For example, the UE 100 always measures the radio quality of the frequencies having higher priorities than a priority of the frequency of the current serving cell, and, as for frequencies having priorities equal to or lower than the priority of the frequency of the current serving cell, measures the radio quality of the frequencies having priorities equal to or lower than the priority of the frequency of the current serving cell when the radio quality of the current serving cell is below a predetermined quality.

In step S13, the UE 100 performs the cell reselection processing of reselecting a cell to which the UE 100 camps on based on the measurement result in step S12. For example, when the priority of a frequency of a neighboring cell is higher than the priority of the current serving cell and the neighboring cell satisfies a predetermined quality standard (i.e., minimal required quality standard) for a predetermined period of time, the UE 100 may perform cell reselection for the neighboring cell. When the frequency priorities of the neighboring cells are the same as the priority of the current serving cell, the UE 100 may rank the radio qualities of the neighboring cells to perform cell reselection for the neighboring cells ranked higher than the ranking of the current serving cell for a predetermined period of time. When the priority of the frequency of the neighboring cell is lower than the priority of the current serving cell, the radio quality of the current serving cell is lower than a certain threshold, and the radio quality of the neighboring cell is continuously higher than another threshold for the predetermined period of time, the UE 100 may perform cell reselection for the neighboring cell.

### Overview of Network Slicing

Network slicing is a technique of virtually dividing a physical network (e.g., a network including the NG-RAN 10 and the 5GC 20) constructed by a telecommunications carrier to create a plurality of virtual networks. Each virtual network is referred to as a “network slice”. Hereinafter, a network slice will also be simply referred to as a “slice”.

Network slicing allows a telecommunications carrier to create slices according to service requirements of different service types, such as enhanced Mobile Broadband (eMBB), Ultra-Reliable and Low Latency Communications (URLLC), and massive Machine Type Communications (mMTC), for example, to optimize network resources.

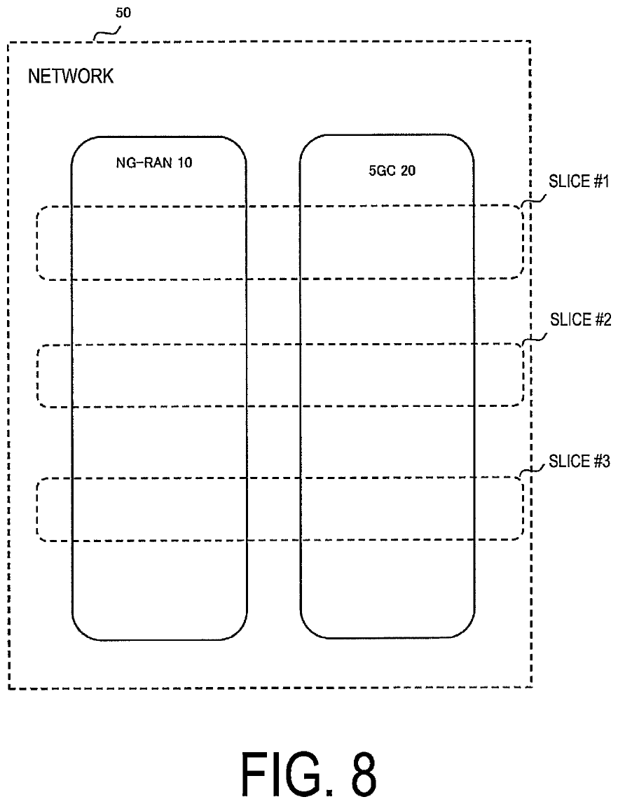

FIG. 8 is a diagram illustrating an example of network slicing.

Three slices (slices #1 to #3) are configured on a network 50 including the NG-RAN 10 and the 5GC 20. The slice #1 is associated with the service type called eMBB, the slice #2 is associated with the service type called URLLC, and the slice #3 is associated with the service type called mMTC. Note that three or more slices may be configured on the network 50. One service type may be associated with a plurality slices.

Each slice is provided with a slice identifier for identifying the slice. Examples of the slice identifier include Single Network Slicing Selection Assistance Information (S-NSSAI). The S-NSSAI includes an 8-bit Slice/Service Type (SST). The S-NSSAI may further include a 24-bit Slice Differentiator (SD). The SST is information indicating a service type with which a slice is associated. The SD is information for differentiating a plurality of slices associated with the same service type. The information including a plurality of pieces of S-NSSAI is referred to as a Network Slice Selection Assistance Information (NSSAI).

One or more slices may be grouped to configure a slice group. A slice group is a group including one or more slices, and a slice group identifier is assigned to the slice group. The slice group may be configured by the core network (e.g., AMF 300), or may be configured by the radio access network (e.g., gNB 200). The UE 100 may be notified of the configured slice group.

Hereinafter, the term “network slice (slice)” may refer to S-NSSAI that is an identifier of a single slice or NSSAI that is a collection of pieces of S-NSSAI. The term “network slice (slice)” may refer to a slice group that is a group of one or more pieces of S-NSSAI or NSSAI.

The UE 100 determines an intended slice that the UE 100 desires to use. The intended slice may be referred to as an “intended slice”. In the first embodiment, the UE 100 determines a slice priority per network slice (intended slice). For example, the NAS of the UE 100 determines the slice priority based on an operation status of an application in the UE 100 and/or a user operation/setting, and notifies the AS of slice priority information indicating the determined slice priority. Note that the NAS of the UE 100 may receive the slice priority information from the AMF 300. In this case, the NAS of the UE 100 may determine the slice priority based on the slice priority information received from the AMF 300.

### Overview of Slice Specific Cell Reselection Procedure

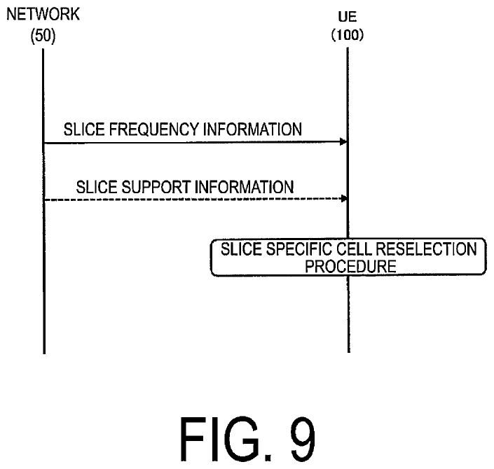

FIG. 9 is a diagram illustrating an overview of a slice specific cell reselection (slice aware cell reselection or slice based cell reselection) procedure.

In the slice specific cell reselection procedure, the UE 100 performs cell reselection processing based on slice frequency information provided from the network 50. The slice frequency information may be provided from the gNB 200 to the UE 100 through broadcast signaling (e.g., a system information block) or dedicated signaling (e.g., RRC release message).

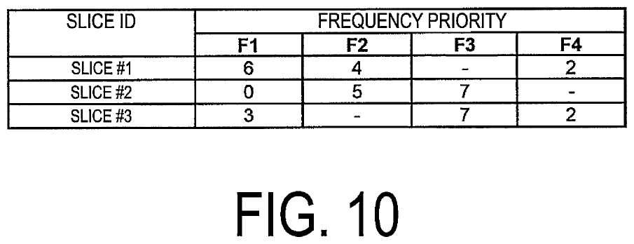

The slice frequency information is information indicating mapping between network slices, frequencies, and frequency priorities. For example, the slice frequency information indicates, for each slice (or slice group), a frequency (one or more frequencies) that supports the slice and a frequency priority assigned to each frequency. FIG. 10 illustrates an example of the slice frequency information.

In the example illustrated in FIG. 10, three frequencies F1, F2, and F4 are associated with the slice #1 as frequencies that support the slice #1. Among these three frequencies, the frequency priority of F1 is “6”, the frequency priority of F2 is “4”, and the frequency priority of F4 is “2”. In the example in FIG. 10, although the priority is set to be higher as the number of a frequency priority becomes greater, the priority may be higher as the number of a frequency priority becomes smaller.

Three frequencies F1, F2, and F3 are associated with the slice #2 as frequencies that support the slice #2. Among these three frequencies, the frequency priority of F1 is “0”, the frequency priority of F2 is “5”, and the frequency priority of F3 is “7”.

The three frequencies F1, F3, and F4 are associated with the slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice specific frequency priority” in order to be distinguished from the absolute priority in the cell reselection procedure of the related art.

As illustrated in FIG. 9, the UE 100 may perform the cell reselection processing, further based on slice support information provided from the network 50. The slice support information may be information indicating mapping between cells (e.g., a serving cell and each neighboring cell) and network slices that are not provided or provided by the cell. For example, a cell may not temporarily provide some or all network slices for a reason of congestion or the like. That is, even for a slice support frequency capable of providing a network slice, some cells in the frequency may not provide network slices. Based on the slice support information, the UE 100 can recognize network slices that are not provided by each cell. Such slice support information may be provided from the gNB 200 to the UE 100 through broadcast signaling (e.g., system information block) or dedicated signaling (e.g., RRC release message).

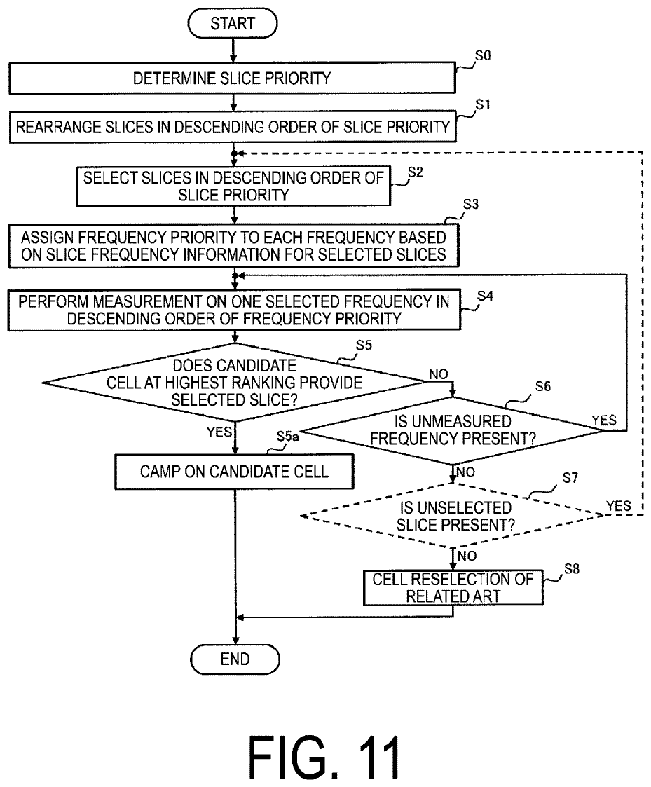

FIG. 11 is a diagram illustrating a basic flow of the slice specific cell reselection procedure. It is assumed that, before starting the slice specific cell reselection procedure, the UE 100 is in the RRC_IDLE state or the RRC_INACTIVE state, and receives and retains the above-mentioned slice frequency information. Note that the “slice specific cell reselection” procedure indicates a “slice specific cell reselection procedure”. In this regard, in the following, “slice specific cell reselection” and “slice specific cell reselection procedure” may be used in the same sense.

In step S0, the NAS of the UE 100 determines the slice identifiers of the intended slices for the UE 100 and the slice priorities of the intended slices, and notifies the AS of the UE 100 of slice priority information including the determined slice priorities. The “intended slice” is an “intended slice”, and includes a slice that is likely to be used, a candidate slice, an intended slice, a slice with which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. Although the priority is higher as the number of a slice priority becomes greater, the priority may be higher as the number of a slice priority becomes smaller.

In step S1, the AS of the UE 100 rearranges the slices (slice identifiers) notified by the NAS in step S0, in descending order of slice priorities. A list of the slices arranged in this manner will be referred to as a “slice list”.

In step S2, the AS of the UE 100 selects one network slice in descending order of the slice priorities. The network slice selected in this manner is referred to as a “selected network slice”.

In step S3, the AS of the UE 100 assigns for the selected network slice a frequency priority to each frequency associated with the selected network slice. More specifically, the AS of the UE 100 specifies the frequency associated with the slice based on the slice frequency information and assigns a frequency priority to the specified frequency. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 based on the slice frequency information (e.g., information in FIG. 10). The AS of the UE 100 refers to a list of frequencies arranged in descending order of frequency priorities as a “frequency list”.

In step S4, the AS of the UE 100 selects one of the frequencies in descending order of frequency priorities for the selected network slice selected in step S2, and performs the measurement processing on the selected frequency. The frequency selected in this manner is referred to as a “selected frequency”. The AS of the UE 100 may rank the cells measured within the selected frequency in descending order of radio qualities. Among the cells measured within the selected frequency, a cell satisfying a predetermined quality standard (i.e., minimal required quality standard) will be referred to as a “candidate cell”.

In step S5, the AS of the UE 100 specifies a cell at the highest rank based on results of the measurement processing in step S4, and determines whether the cell provides the selected network slice based on the slice support information. When it is determined that the cell at the highest rank provides the selected network slice (step S5: YES), the AS of the UE 100 reselects the cell at the highest rank and camps on that cell in step S5a.

On the other hand, when it is determined that the cell at the highest rank does not provide the selected network slice (step S5: NO), the AS of UE 100 determines in step S6 whether a frequency that is not yet measured is present on the frequency list created in step S3. In other words, the AS of the UE 100 determines whether a frequency assigned in step S3 other than the selected frequency is present in the selected network slice. When it is determined that a frequency that is not yet measured is present (step S6: YES), the AS of the UE 100 resumes the processing for the frequency ranked at the next highest frequency priority, and performs the measurement processing using that frequency as a selected frequency (returns to the processing of step S4).

When it is determined that a frequency that is not yet measured is not present on the frequency list created in step S3 (step S6: NO), the AS of the UE 100 may determine in step S7 whether an unselected slice is present on the slice list created in step S1. In other words, the AS of the UE 100 may determine whether a network slice other than the selected network slice is present on the slice list. When it is determined that an unselected slice is present (step S7: YES), the AS of the UE 100 resumes the processing for the network slice ranked at the next highest slice priority, and selects that network slice as a selected network slice (returns to the processing of step S2). Note that, in the basic flow indicated in FIG. 11, the processing in step S7 may be omitted.

When it is determined that an unselected slice is not present (step S7: NO), the AS of the UE 100 performs cell reselection processing of related art in step S8. The cell reselection processing of related art may mean an entirety of the typical (or legacy) cell reselection procedure illustrated in FIG. 7. The cell reselection processing of related art may also mean only cell reselection processing (step S13) illustrated in FIG. 7. In the latter case, the UE 100 may use the measurement result in step S4 without measuring the radio qualities of the cells again.

### (Paging)

Paging according to the first embodiment will be described.

Paging is a technique for invoking the UE 100 in an RRC_IDLE state or an RRC_INACTIVE state from the network. Paging is used for, for example, reception of data (voice or the like) or notification of emergency information.

Paging includes CN-initiated paging and RAN-initiated paging. CN-initiated paging may be referred to as “CN paging”. RAN-initiated paging may be referred to as “RAN paging”.

The CN paging is performed on the UE 100 in the RRC_IDLE state. For example, a core network device (e.g., AMF 300) of the CN 20 that has received the notification of downlink data addressed to the UE 100 generates a PAGING message including a Tracking Area Identity (TAI) list. The core network device transmits the PAGING message to each gNB 200 included in a Tracking Area (TA). Each gNB 200 (or each cell) transmits a Paging message including an identifier of the UE 100 in response to reception of the PAGING message. Thus, paging messages are simultaneously transmitted from each gNB 200 (or each cell) included in the TA.

On the other hand, the RAN paging is performed on the UE 100 in the RRC_INACTIVE state. For example, the gNB 200 having received the downlink data addressed to the UE 100 transmits the RAN paging message to another gNB (or another cell) in a RAN-based Notification Area (RNA). Each gNB 200 (or each cell) transmits a Paging message including the identifier of the UE 100. Thus, the paging messages are simultaneously transmitted from each gNB 200 (or each cell) included in the RNA.

The UE 100 in the RRC_IDLE state or the RRC_INACTIVE state can be used for Discontinuous Reception (DRX) to suppress power consumption. The UE 100 monitors a paging channel at one Paging Occasion (PO) per DRX cycle.

The UE 100 in the RRC_IDLE state monitors a paging channel of CN paging. According to CN paging, the UE 100 monitors a paging channel using a shorter cycle (DRX cycle) between a default cycle broadcast using system information (SIB: System Information Block), and a cycle that has been configured using a NAS message and unique to the UE 100.

On the other hand, the UE 100 in the RRC_INACTIVE state monitors a paging channel of RAN paging. According to RAN paging, the UE 100 uses the shortest cycle (DRX cycle) among the default cycle transmitted using the SIB, the cycle that has been configured using the NAS message and unique to the UE 100, and the cycle that has been configured using the RRC message and unique to the UE 100.

In this regard, both a Paging Occasion (PO) of CN paging and a Paging Occasion (PO) of RAN paging are based on the same UE ID, and therefore overlap.

When receiving the paging message using the paging channel, the UE 100 in the RRC_IDLE state or the RRC_INACTIVE state recognizes that there has been an incoming call or the like addressed to the UE 100. The UE 100 executes an RRC connection establishment procedure with respect to the serving cell. Thus, the UE 100 can be connected to the network, transition to the RRC_CONNECTED state, and exchange messages (such as RRC messages) with the network.

### Communication Control Method According to First Embodiment

It is assumed that slices are associated with a paging message. The current 3GPP specifications do not enable the UE 100 to recognize the slice associated with the paging message. It is assumed that the UE 100 executes the RRC connection establishment procedure for a serving cell on an occasion of reception of the paging message. In this case, although the UE 100 can establish RRC connection with the serving cell, if the serving cell does not support the slice, the UE 100 cannot receive provision of a service associated with the slice from the serving cell. In this case, the UE 100 is handed over to a neighboring cell to receive provision of other services. As described above, the serving cell may not necessarily be an appropriate cell for the UE 100.

In the first embodiment, the UE 100 is enabled to connect to an appropriate cell.

In the first embodiment, a network slice associated with paging may be referred to as a “Mobile Terminated (MT) slice”. An MT slice may be a slice used for paging. The MT slice may be a slice associated with a paging message. The MT slice may be a slice associated with paging.

In the first embodiment, information indicating network slices corresponding to MT slices may be referred to as “MT slice information”. The slices indicated by the MT slice information are the MT slices. The slices and the MT slices are associated by the MT slice information.

It is assumed in the first embodiment that the network can recognize what kind of a slice the slice corresponding to the MT slice is. In the first embodiment, the core network device (e.g., AMF 300) included in the CN 20 transmits the MT slice information to the UE 100.

More specifically, the core network device (e.g., AMF 300) transmits the MT slice information indicating the network slices associated with paging to the user equipment (e.g., UE 100).

The UE 100 can recognize the slices associated with the paging by checking the MT slice information. When, for example, the UE 100 can recognize whether the serving cell supports the slices, the UE 100 can also perform the RRC connection establishment procedure on the serving cell, or perform a slice specific cell reselection procedure for connecting to a neighboring cell. Accordingly, the UE 100 can connect to an appropriate cell.

### Operation Example According to First Embodiment

An operation example according to the first embodiment will be described.

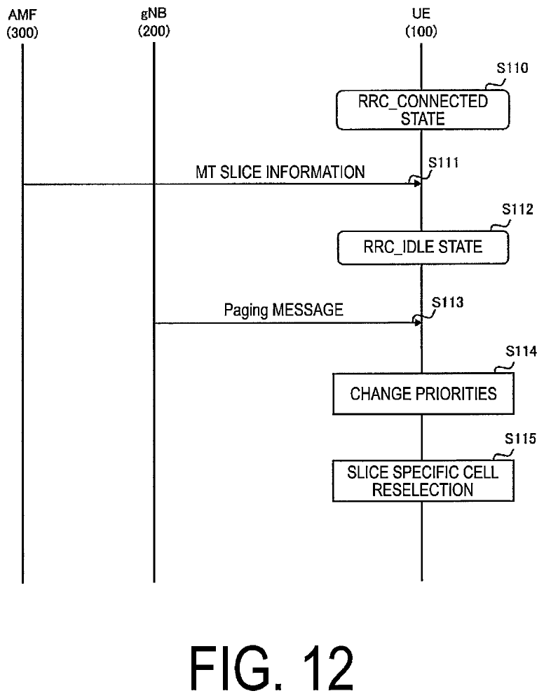

FIG. 12 is a diagram illustrating the operation example according to the first embodiment. FIG. 12 illustrates the example of CN paging. Note that, before performing processing in FIG. 12, the UE 100 receives slice frequency information from the gNB 200. The slice frequency information is information indicating mapping between network slices, frequencies, and frequency priorities as described above (e.g., FIG. 10).

As illustrated in FIG. 12, in step S110, the UE 100 is in the RRC_CONNECTED state.

In step S111, the AMF 300 transmits a NAS message including the MT slice information to the UE 100.

First, the AMF 300 may include the slice priority information together with the MT slice information in the NAS message to transmit. The AMF 300 may include the MT slice information in another NAS message different from the NAS message including the slice priority information to transmit. The NAS of the UE 100 receives the MT slice information and slice priority information, and outputs the MT slice information and the slice priority information to the AS of the UE 100. The AS of the UE 100 may store the MT slice information and the slice priority information in a memory.

Second, the AMF 300 may transmit to the UE 100 change indication information (e.g., first change instruction information) indicating change of the slice priorities of the MT slices. The AMF 300 transmits the NAS message including the change indication information to the NAS of the UE 100. The AMF 300 may transmit the change indication information together with the MT slice information in one NAS message. The AMF 300 may include the change indication information in another NAS message different from the NAS message including the MT slice information to transmit. The NAS of the UE 100 outputs the change indication information to the AS of the UE 100. The AS of the UE 100 may store the change indication information in the memory.

Third, the AMF 300 may transmit to the UE 100 a bias value to be added to the slice priorities of the MT slices. The UE 100 having received the bias value adds the bias value to the slice priorities of the MT slices. The bias value may be included in one NAS message together with the MT slice information and transmitted from the AMF 300. The bias value may be included in another NAS message different from that of the MT slice information and transmitted from the AMF 300. For example, any value from “−7” to “+7” may be set as the bias value. The bias value may be defined in the specification (or the bias value may be hard-coded in the UE 100).

In step S112, the UE 100 transitions to an RRC_IDLE state.

In step S113, the gNB 200 transmits the paging message to the UE 100. The gNB 200 transmits the paging message of the RRC message in response to reception of the paging message that is an NG message from the AMF 300.

In step S114, the UE 100 changes the slice priorities of the MT slices based on the MT slice information (step S111). The UE 100 may change the slice priorities of the MT slices according to the change indication information.

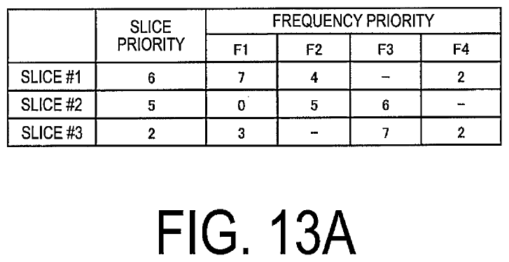

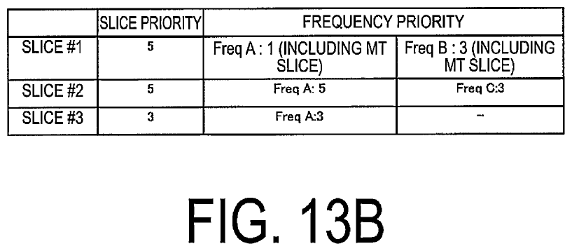

FIG. 13A is a diagram illustrating mapping among slices, slice priorities, and frequency priorities. It is assumed that the UE 100 has acquired the mapping illustrated in FIG. 13A from the slice frequency information. In the example in FIG. 13A, the slice #1 has the highest slice priority, and the slice #3 has the lowest slice priority. As for the frequency priorities, too, in the slice #1, the frequency F1 has the highest frequency priority, and the frequency F4 has the lowest frequency priority. Both the slice priorities and the frequency priorities indicate examples where, as the numbers are larger, the priorities are higher.

For example, it is assumed that the MT slice information indicates that the slice #3 is a slice corresponding to the MT slice. In such a case, the UE 100 changes the slice priority of the slice #3 that is the MT slice. More specifically, the UE 100 can make the following change.

First, the UE 100 may change the slice priorities by changing the slice priorities of slices corresponding to the MT slices to higher slice priorities than the slice priorities of slices that are not the MT slices. For example, in the case in FIG. 13A, the UE 100 may change the slice priority “2” of the slice #3 to a higher slice priority than the slice priority “5” of the slice #2. The UE 100 may change the slice priority “2” of the slice #3 to the highest priority (i.e., intended slice).

Second, the UE 100 may change the slice priorities by changing the slice priorities of the slices corresponding to the MT slices to the same slice priorities as the slice priorities of the slices that are not the MT slices. For example, in the case in FIG. 13A, the UE 100 may set the slice priority “2” of the slice #3 to “5” that is the same as the slice priority of the slice #2.

Third, the UE 100 may change the slice priorities by changing the slice priorities of the slices corresponding to the MT slices to lower slice priorities than the priorities of the slices that are not the MT slices. For example, when the slice #2 is the MT slice and the slice #3 is not the MT slice in FIG. 13A, the UE 100 may change the slice priority of the slice #2 by changing the slice priority “5” of the slice #2 to a lower priority than the slice priority “2” of the slice #3.

Fourth, the UE 100 may change the slice priorities by adding a bias value to the slice priorities of the MT slices. For example, in the example in FIG. 13A, the UE 100 adds a bias value (e.g., “7”) to the slice priority of the slice #3 that is the MT slice, and changes the slice priority of the slice #3.

Referring back to FIG. 12, in step S115, the UE 100 executes the slice specific cell reselection procedure according to the changed slice priorities. Thereafter, the UE 100 executes an RRC connection establishment procedure for the reselected neighboring cell.

### Another Example of First Embodiment

In the first embodiment, it has been described that the UE 100 receives the MT slice information (step S111) before the paging message (step S113). However, the present disclosure is not limited thereto. For example, the UE 100 may receive the paging message (step S113) and the MT slice information (step S111) at the same timing. Even in this case, the UE 100 can change the slice priorities of the MT slices based on the MT slice information as in the first embodiment (step S114).

The example has been described in the first embodiment where the MT slices are associated with slices. However, the present disclosure is not limited thereto. For example, Mobile Originated (MO) slices may be associated with slices. The MO slice is, for example, a slice used in the UE 100 of a Mobile Initiated Connection Only (MICO) mode. In the UE 100 of the MICO mode, transmission to the network can be performed in the RRC_CONNECTED state during an extended connected time without performing paging. For example, the MO slices are associated with the transmission. The AMF 300 transmits to the UE 100 information indicating slices corresponding to the MO slices (such information may be referred to as “MO slice information”). Based on the MO slice information, the UE 100 can perform uplink transmission in the MICO mode using the slice associated with the MO slice preferentially over other slices.

The example has been described in the first embodiment where the UE 100 changes the slice priorities. However, the present disclosure is not limited thereto. For example, the AMF 300 may change the slice priorities. In this case, the AMF 300 transmits to the UE 100 the slice priority information including the changed slice priorities (i.e., changed slice priorities) without transmitting the MT slice information (or together with the MT slice information). Thereafter, the UE 100 performs the same processing as that of the first embodiment (from step S112 to step S115). The slice priorities may be changed in the same way as that in step S114.

The example of CN paging has been described in the first embodiment. For example, RAN paging may be performed in the first embodiment. In this case, the UE 100 is in an RRC_INACTIVE state instead of the RRC_IDLE state (step S112). However, the UE 100 may be in the RRC_INACTIVE state before receiving the MT slice information (step S111). When an occasion to transmit a paging message comes (when, for example, the UE 100 receives downlink data addressed to the UE 100 from the UPF), the gNB 200 transmits the paging message to the UE 100 (step S113).

### Second Embodiment

A second embodiment will be described. In the second embodiment, differences from the first embodiment will mainly be described.

The second embodiment is an example where frequencies that support the MT slices are notified. Hereinafter, information indicating the frequencies that support the MT slices may be referred to as “MT slice support frequency information”.

The gNB 200 recognizes the frequencies that support the MT slices, and can transmit the MT slice support frequency information to the UE 100. More specifically, first, the base station (e.g., gNB 200) transmits the MT slice support frequency information indicating the frequencies that support the MT slices to the user equipment (e.g., UE 100).

Thus, for example, the UE 100 can select frequencies that support the MT slices preferentially over other frequencies, and execute the slice specific cell reselection procedure. The UE 100 can reselect a neighboring cell that supports the MT slices from among the cells that support the frequencies and connect to the cell. Accordingly, the UE 100 can connect to an appropriate cell.

### Operation Example According to Second Embodiment

An operation example according to the second embodiment will be described.

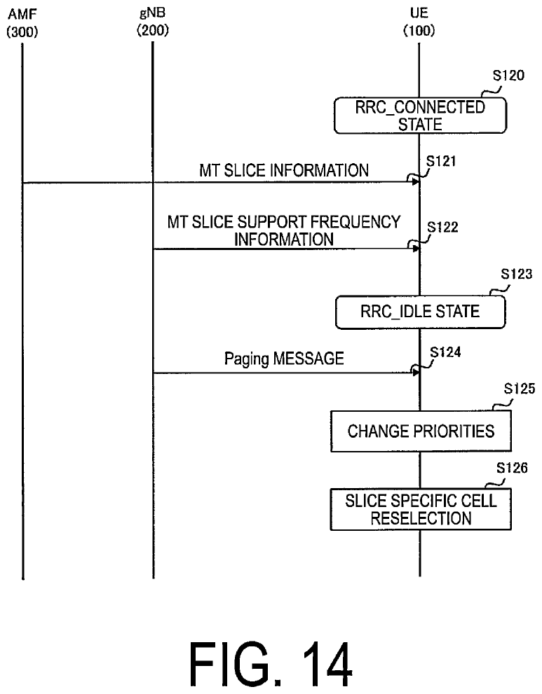

FIG. 14 is a diagram illustrating an operation example according to the second embodiment. FIG. 14 illustrates the example of CN paging.

As illustrated in FIG. 14, in step S120, the UE 100 is in the RRC_CONNECTED state.

In step S121, the AMF 300 transmits the MT slice information to the UE 100 as in the first embodiment.

In step S122, the gNB 200 transmits the MT slice support frequency information to the UE 100. The gNB 200 may broadcast a System Information Block (SIB) including the MT slice support frequency information. The gNB 200 may transmit an individual message (e.g., RRC release message) including the MT slice support frequency information.

First, the MT slice support frequency information may be transmitted together with the slice frequency information in one RRC message from the gNB 200. The MT slice support frequency information may be included and transmitted in another RRC message different from the RRC message including the frequency priorities.

Second, the gNB 200 may transmit, to the UE 100, change indication information (e.g., second change instruction information) indicating change of the frequency priorities of the frequencies that support the MT slices. The gNB 200 may transmit an RRC message (that may be, for example, an SIB or may be an RRC release message) including the change indication information. The gNB 200 may transmit the change indication information together with the MT slice support frequency information in one RRC message. The gNB 200 may include change indication information in another RRC message different from the MT slice support frequency information to transmit.

Third, the gNB 200 may transmit to the UE 100 a bias value to be added to the frequency priorities of the frequencies that support the MT slices. The UE 100 having received the bias value adds the bias value to the frequency priorities of the frequencies that support the MT slices. The bias value may be included in one RRC message together with the MT slice support frequency information, and transmitted from the gNB 200. The bias value may be included in another RRC message different from that of the MT slice support frequency information and transmitted from the gNB 200. The bias value of the frequency may also be set to any value within, for example, a range from “−7” to “+7”. The bias values may be defined in the specification (or the bias value may be hard-coded in the UE 100).

In step S123, the gNB 200 transitions to the RRC_IDLE state.

In step S124, the gNB 200 transmits a paging message to the UE 100 in response to reception of the paging message that is an NG message from the AMF 300.

In step S125, the UE 100 changes the slice priorities of the MT slices based on the MT slice information, and changes the frequency priorities of the frequencies that support the MT slices based on the MT slice support frequency information. The UE 100 may change the frequency priorities of the frequencies that support the MT slices according to the change indication information. The UE 100 may change both the slice priorities and the frequency priorities according to the change indication information.

FIG. 13B is a diagram illustrating mapping among slices, slice priorities, and frequency priorities. In the example in FIG. 13B, the slice #1 is an MT slice. It is assumed that the UE 100 has acquired the relation illustrated in FIG. 13B from the slice frequency information and the MT slice information. The UE 100 may change the frequency priorities of the frequencies that support the MT slices, for example, as follows.

First, the UE 100 may change the frequency priorities by changing the frequency priorities of the frequencies that support the MT slices to higher frequency priorities than the frequency priorities of the frequencies that support slices that are not the MT slices. In the case in FIG. 13B, the UE 100 may cause the frequency priorities (“1” and “3”) of frequencies (the frequencies A and the frequencies B) of the slice #1 to be higher than the frequency priority (“3”) of the frequencies (frequencies A) of the slice #3. The UE 100 may cause the frequency priorities (“1” and “3”) of the frequencies (the frequencies A and the frequencies B) of the slice #1 to be higher than the highest priority (“5”) among the frequencies (the frequencies A and the frequencies C) of the slice #2. The UE 100 may cause the frequency priorities of the frequencies (the frequencies A and the frequencies B) of the slice #1 to be the highest frequency priorities.

Second, the UE 100 may change the frequency priorities by changing the frequency priorities of the frequencies that support the MT slices to the same frequency priorities as the frequency priorities of the frequencies that support the slices that are not the MT slices. In the case in FIG. 13B, the UE 100 may change the frequency priorities of the frequencies (the frequencies A and the frequencies B) of the slice #1 to the same frequency priority as the frequency priorities of the frequencies (frequencies A) of the slice #3. In this case, the UE 100 may cause the frequency priorities of the same frequencies (frequencies A) to be the same between the slice #1 and the slice #3. The UE 100 may cause all the frequencies (the frequencies A and the frequencies B) included in the slice #1 to be the same frequency priority as the frequencies (frequencies A) of the slice #3. The UE 100 may change the frequency priorities of the frequencies (the frequencies A and the frequencies B) of the slice #1 to the same frequency priorities as the frequency priorities of the frequencies (the frequencies A or the frequencies C) of the slice #2. In this case, too, the UE 100 may change the same frequencies (frequencies A) of the slice #1 and the slice #2 to the same frequency priority. The UE 100 may change the frequency priorities of all the frequencies (the frequencies A and the frequencies B) included in the slice #1 to the same frequency priorities as any one of the frequencies (the frequency A or B) included in the slice #2.

Third, the UE 100 may change the frequency priorities by changing the frequency priorities of the frequencies that support the MT slices to lower frequency priorities than the frequency priorities of frequencies that support slices that are not the MT slices. For example, in FIG. 13B, when the slice #2 is the MT slice and the slice #1 is not the MT slice, the UE 100 may change the frequency priorities by changing the frequency priorities of frequencies (the frequencies A and the frequencies C) included in the slice #2 to lower frequency priorities than the frequency priorities of the frequencies (the frequencies A and the frequencies B) included in the slice #1. In this case, the UE 100 may cause the frequency priorities of all the frequencies (the frequencies A and the frequencies C) included in the slice #2 to be lower than the frequency priority of any one of the frequencies (the frequencies A or the frequencies B) included in the slice #1. The UE 100 may cause the frequency priorities of all the frequencies (the frequencies A and the frequencies C) included in the slice #2 to be lower than the frequency priority of the lowest frequency (the frequency priority of the frequency C) among the frequencies included in the slice #1.

Fourth, the UE 100 may change the frequency priorities of frequencies that support the MT slice by adding a bias value to the frequency priorities of the frequencies that support the MT slices.

Note that the slice priorities of the MT slices may be changed in the same way as that in the first embodiment.

Returning back to FIG. 14, in step S126, the UE 100 executes the slice specific cell reselection procedure according to the changed slice priorities and the changed frequency priorities. Then, the UE 100 executes the RRC connection establishment procedure for the neighboring cell after reselection.

### Another Example of Second Embodiment

The example has been described in the second embodiment where the UE 100 changes the frequency priorities. However, the present disclosure is not limited thereto. For example, the gNB 200 may change the frequency priorities. In this case, the gNB 200 may transmit the slice frequency information including the changed frequency priorities (i.e., changed frequency priorities) to the UE 100 without transmitting the MT slice support frequency information (or together with the MT slice support frequency information).

The example of CN paging has been described in the second embodiment. However, the present disclosure is not limited thereto. For example, RAN paging may be performed in the second embodiment. In this case, the UE 100 is in the RRC_INACTIVE state instead of the RRC_IDLE state (step S123). When an occasion to transmit a paging message comes (e.g., when downlink data addressed to the UE 100 is received from the UPF), the gNB 200 transmits the paging message to the UE 100 (step S124).

### Third Embodiment

A third embodiment will be described. In the third embodiment, differences from the first embodiment and the second embodiment will mainly be described.

The third embodiment is an example where a timing at which paging occurs is notified. More specifically, first, the core network device (e.g., AMF 300) transmits timing information indicating the timing at which paging occurs to the user equipment (e.g., UE 100).

Thus, for example, the UE 100 can recognize the timing at which paging occurs. Accordingly, the UE 100 can predict in advance that a paging message is transmitted from the gNB 200 based on the timing of occurrence of paging. The UE 100 can make preparations in advance to enable execution of the slice specific cell reselection procedure of, for example, changing the priorities of the MT slices associated with the paging when receiving the paging message from the gNB 200. Thus, the UE 100 can connect to an appropriate cell.

Hereinafter, paging or reception of a paging message may be simply referred to as “Mobile Terminated (MT)”.

### Operation Example According to Third Embodiment

An operation example according to the third embodiment will be described.

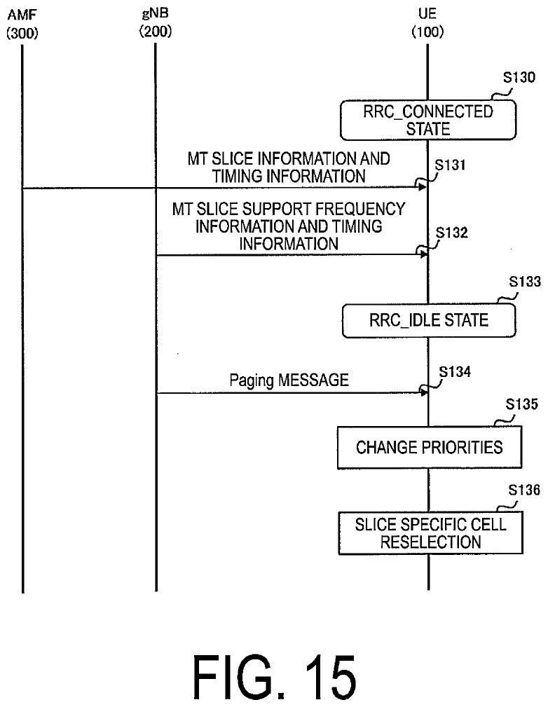

FIG. 15 is a diagram illustrating the operation example according to the third embodiment. Note that FIG. 15 illustrates the example of CN paging.

As illustrated in FIG. 15, in step S130, the UE 100 is in the RRC_CONNECTED state.

In step S131, the AMF 300 transmits the MT slice information and the timing information to the UE 100. More specifically, the AMF 300 transmits a NAS message including the MT slice information and the timing information to the UE 100.

The timing information indicates a timing at which paging occurs. The timing information may indicate a timing at which MT occurs. The timing information may indicate a timing at which a paging message associated with MT slices is transmitted. The MT slice information transmitted together with the timing information indicates MT slices associated with paging that is a target of the timing information.

The timing information may be indicated by a day of the week, a date, and/or a time at which MT slices occur (or MT occurs). The timing information may include a place at which MT slices occur (or a place at which MT occurs). The place may be indicated by a Tracking Area Code (TAC) and/or a Physical Cell Identifier (Physical Cell ID (PCI)).

In step S132, the gNB 200 transmits the MT slice support frequency information and the timing information to the UE 100. More specifically, the gNB 200 transmits an RRC message (such as an SIB or an RRC release message) including the MT slice support frequency information and the timing information. The timing information may be identical to the timing information (step S131) transmitted by the AMF 300.

Step S133 and step S134 are the same as step S112 and step S113 in the second embodiment, respectively.

In step S135, the UE 100 changes the slice priorities of the MT slices based on the MT slice information. At this time, the UE 100 may transmit to the AMF 300 the NAS message including information indicating that the slice priorities of the MT slices have been changed. The UE 100 changes the frequency priorities of the frequencies that support the MT slices based on the MT slice support frequency information. At this time, the UE 100 may change the priorities based on the timing information (step S131 and/or step S132). For example, the UE 100 may change the priorities at the timing indicated by the timing information. The UE 100 may predict reception of the paging message (step S134) based on the timing information and change priorities before reception of the paging message.

In step S136, the UE 100 executes the slice specific cell reselection procedure using the changed priorities.

### Another Example of Third Embodiment

The example of CN paging has been described in the third embodiment. However, the present disclosure is not limited thereto. For example, RAN paging may also be applied to the third embodiment. In this case, in step S133, the UE 100 may be in the RRC_INACTIVE state instead of the RRC_IDLE state.

### Fourth Embodiment

A fourth embodiment will be described. As for the fourth embodiment, too, differences from the first embodiment and the second embodiment will mainly be described.

The example has been described in the third embodiment where the network notifies the UE 100 of the MT slice information and the timing information. The fourth embodiment is an example where the UE 100 notifies the network of the MT slice information and the timing information.

For example, an application layer of the UE 100 may transmit data periodically. Before entering the RRC_IDLE state, the UE transmits slices (i.e., MT slices) associated with the paging and an occurrence timing of paging to the network. Thus, for example, the network can generate the MT slices at the timing, and the gNB 200 can transmit the paging message at the timing. By changing the priorities of the MT slices and performing the slice specific cell reselection procedure when receiving the Paging message, the UE 100 can connect to a neighboring cell that supports the MT slices as in the first embodiment. Accordingly, the UE 100 can connect to an appropriate cell.

In the fourth embodiment, the UE 100 transmits the MT slice information and the timing information to the network.

More specifically, first, the user equipment (e.g., UE 100) transmits the MT slice information indicating network slices associated with paging, and timing information indicating a timing at which paging occurs to the core network device (e.g., AMF 300). Second, the user equipment transmits the MT slice support frequency information indicating the frequencies that support the network slices and the timing information to the base station (e.g., gNB 200).

### Operation Example According to Fourth Embodiment

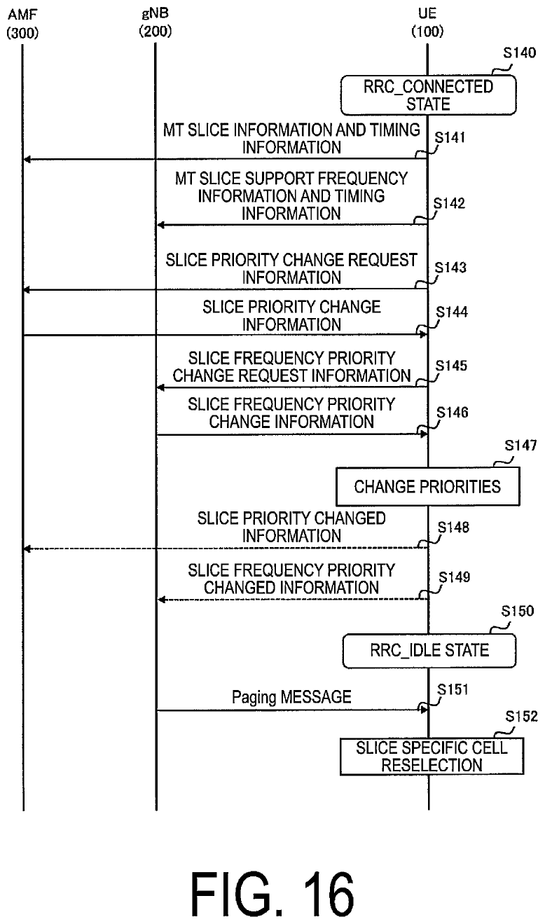

FIG. 16 is a diagram illustrating an operation example according to the fourth embodiment. FIG. 16 also illustrates the example of CN paging.

As illustrated in FIG. 16, in step S140, the UE 100 is in the RRC_CONNECTED state.

In step S141, the UE 100 transmits the MT slice information and the timing information to the AMF 300. More specifically, the NAS of the UE 100 transmits a NAS message including the MT slice information and the timing information to the AMF 300. The timing information is, for example, the same as that in the third embodiment.

In step S142, the UE 100 transmits the MT slice support frequency information and the timing information to the gNB 200. More specifically, the AS of the UE 100 transmits to the gNB 200 an RRC message including the MT slice support frequency information and the timing information. The timing information is also, for example, the same as the timing information transmitted in step S141.

In step S143, the UE 100 transmits to the AMF 300 slice priority change request information indicating to request (demand) to change slice priorities of the MT slices. More specifically, the NAS of UE 100 transmits a NAS message including the slice priority change request information to the AMF 300.

In step S144, in response to reception of the slice priority change request information, the AMF 300 transmits to the UE 100 the slice priority change information indicating to change the slice priorities of the MT slices. More specifically, the AMF 300 transmits the NAS message including the slice priority change information to the NAS of the UE 100. As in the first embodiment, the UE 100 may be able to change the slice priorities of the MT slices by receiving the slice priority change information.

In step S145, the UE 100 transmits to the gNB 200 slice frequency priority change request information indicating to request (or demand) to change the frequency priorities of the frequencies that support the MT slices. More specifically, the AS of UE 100 transmits to the gNB 200 an RRC message including the slice frequency priority change request information.

In step S146, in response to reception of the slice frequency priority change request information, the gNB 200 transmits to the UE 100 slice frequency priority change information indicating a change in the frequency priorities of the frequencies that support the MT slices. More specifically, the gNB 200 transmits the RRC message including the slice frequency priority change information to the AS of the UE 100.

In step S147, the UE 100 changes the priorities. The UE 100 may change the slice priorities of the MT slices in response to reception of the slice priority change information (step S144). The UE 100 may also change the priorities of the frequencies that support the MT slices in response to reception of the slice frequency priority change information (step S146).

Step S150 and step S151 are the same as step S112 and step S113 in the first embodiment.

In step S152, the slice specific cell reselection procedure is executed according to the changed slice priorities and the changed frequency priorities.

### Another Example According to Fourth Embodiment

The example has been described in the fourth embodiment where the UE 100 requests the network to change the priorities (from step S143 to step S146). For example, the UE 100 may change the priorities (step S147) without requesting the network to change the priorities. In this case, as illustrated in FIG. 16, after changing the priorities (step S147) without performing step S143 to step S146, the UE 100 transmits to the AMF 300 slice priority changed information indicating that the slice priorities of the MT slices have been changed (step S148). The slice priority changed information may be included and transmitted in a NAS message. Then, the UE 100 transmits to the gNB 200 (e.g., base station) slice frequency priority changed information indicating that the priorities of the frequencies that support the MT slices have been changed (step S149). The slice frequency priority changed information may be included and transmitted in an RRC message.

As described above, in the fourth embodiment, the UE 100 requests the network to change the priorities (from step S143 to step S146), or the UE 100 notifies the network that the priorities have been changed (step S148 and step S149). This also matches with the 3GPP's requirement that the network controls slice priorities and frequency priorities.

Note that RAN paging may also be applied in the fourth embodiment as in the first embodiment and the like.

### Fifth Embodiment

A fifth embodiment will be described. As for the fifth embodiment, too, differences from the first embodiment and the second embodiment will mainly be described.

An example will be described in the fifth embodiment where changed slice priorities of MT slices and changed frequency priorities of frequencies that support the MT slices are reset to original priorities. More specifically, first, after executing the slice specific cell reselection procedure, the user equipment (e.g., UE 100) resets changed slice priorities of network slices (e.g., MT slices) to pre-change priorities. Second, after executing the slice specific cell reselection procedure, the user equipment resets the changed frequency priorities of the frequencies that support the network slices to the pre-change frequency priorities.

If the UE 100 can connect to a neighboring cell that supports the MT slices, the MT slices may not be used thereafter. By resetting the changed slice priorities of the MT slices to the pre-change slice priorities, the UE 100 can execute the slice specific cell reselection procedure without preferentially using the MT slices. Accordingly, the UE 100 can appropriately execute the slice specific cell reselection procedure by resetting the priorities to the pre-change priorities after connecting to the neighboring cell that supports the MT slices. Accordingly, the UE 100 can connect to an appropriate cell.

### Operation Example According to Fifth Embodiment

An operation example according to the fifth embodiment will be described.

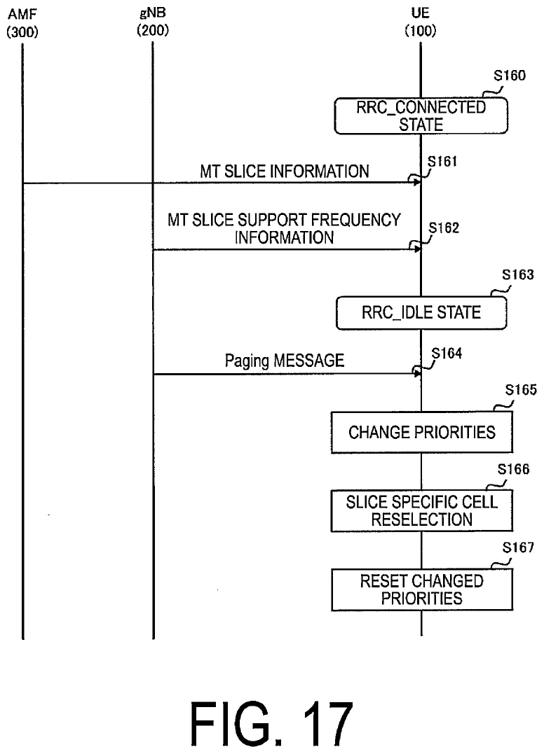

FIG. 17 is a diagram illustrating the operation example according to the fifth embodiment. FIG. 17 illustrates the operation example where both CN paging and RAN paging are supported.

Step S160 to step S164 are the same as step S120 to step S124 in the second embodiment, respectively.

In step S165, the UE 100 changes the slice priorities of the MT slices and the frequency priorities of the frequencies that support the MT slices. At this time, the UE 100 stores in the memory, for example, the pre-change slice priorities of the MT slices and the pre-change frequency priorities of the frequencies that support the MT slices. The UE 100 changes the priorities after storing the priorities in the memory. The UE 100 may store in the memory the pre-change slice priorities of the MT slices, and the pre-change frequency priorities of the frequencies that support the MT slices.

In step S166, the UE 100 executes the slice specific cell reselection procedure according to the changed priorities.

In step S167, the UE 100 resets the changed priorities back to the original priorities. The UE 100 resets the slice priorities to the original slice priorities by, for example, changing the changed slice priorities to the pre-change slice priorities stored in the memory. The UE 100 may reset the priorities of the MT slices to the original priorities by changing the changed slice priorities of the MT slices to the pre-change slice priorities stored in the memory. The UE 100 resets the frequency priorities to the original frequency priorities by, for example, changing the changed frequency priorities to the pre-change slice priorities stored in the memory. The UE 100 may reset the frequency priorities to the original frequency priorities by changing the changed frequency priorities of the frequencies that support the MT slices to the pre-change frequency priorities stored in the memory.

### Another Example of Fifth Embodiment

The example has been described in the fifth embodiment where the priorities are reset (step S167) after execution of the slice specific cell reselection procedure (step S166). For example, the priorities may be reset immediately after the UE 100 executes the slice specific cell reselection procedure (step S166) and starts the RRC connection establishment procedure for a neighboring cell that supports an MT cell. The priorities may be reset at any timing after the UE 100 starts the RRC connection establishment procedure.

In the fifth embodiment, the AMF 300 may transmit to the UE 100 a NAS message including information indicating whether the priorities are reset. The gNB 200 may transmit to the UE 100 an RRC message including the information indicating whether the priorities are reset.

The UE 100 may transmit to the AMF 300 a NAS message including information requesting to reset the priorities. In this case, the AMF 300 may transmit a NAS message including information indicating to reset the priorities in response to reception of the information.

The NAS of the UE 100 may notify the AS of the UE 100 of the information requesting to reset the priorities, and the AS of the UE 100 may transmit the RRC message including the information to the gNB 200. In this case, in response to reception of the information, the gNB 200 transmits to the AS of the UE 100 the RRC message including information indicating to reset the priorities. The AS of the UE 100 notifies the NAS of the UE 100 of that resetting of the priorities has been permitted.

In the fifth embodiment, resetting of priorities may be defined in the specification (or may be configured by hard-coding).

In the fifth embodiment, the UE 100 may be able to select whether to reset the priorities.

### Other Embodiments

A program causing a computer to execute each of the processing performed by the UE 100 or the gNB 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on” used in the present disclosure do not mean “based only on” and “only depending on”, unless specifically stated otherwise. The phrase “based on” means both “based only on” and “based at least in part on”. Similarly, the phrase “depending on” means both “only depending on” and “at least partially depending on”. The terms “include” and “comprise” do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

### Supplementary Note

### Supplementary Note 1

A communication control method in a mobile communication system, the communication control method including transmitting, by a core network device to a user equipment, Mobile Terminated (MT) slice information indicating a network slice associated with paging.

### Supplementary Note 2

The communication control method described in supplementary note 1 further includes:
at a base station, transmitting a paging message to the user equipment;
at the user equipment, changing a slice priority of the network slice based on the MT slice information; and
at the user equipment, executing a slice specific cell reselection procedure according to the changed slice priority.

### Supplementary Note 3

According to the communication control method described in supplementary note 1 or 2, the transmitting the MT slice information to the user equipment includes transmitting, by the core network device to the user equipment, first change indication information indicating change of a slice priority of the network slice.

### Supplementary Note 4

The communication control method described in any one of supplementary note 1 to supplementary note 3 further includes transmitting, by a base station to the user equipment, MT slice support frequency information indicating a frequency that supports the network slice.

### Supplementary Note 5

The communication control method described in any one of supplementary note 1 to supplementary note 4 further including:
at the user equipment, changing a frequency priority of the frequency that supports the network slice based on the MT slice support frequency information; and
at the user equipment, executing a slice specific cell reselection procedure according to the changed frequency priority.

### Supplementary Note 6

The communication control method described in any one of supplementary note 1 to supplementary note 5, the transmitting the MT slice support frequency information to the user equipment includes transmitting, by the base station to the user equipment, second change indication information including information indicating change of the frequency priority of the frequency that supports the network slice.

### Supplementary Note 7

According to the communication control method described in any one of supplementary note 1 to supplementary note 6, the transmitting the MT slice information to the user equipment includes transmitting, by the core network device to the user equipment, timing information indicating a timing at which the paging occurs.

### Supplementary Note 8

According to the communication control method described in any one of supplementary note 1 to supplementary note 7, the transmitting the MT slice support frequency information to the user equipment includes transmitting, by the base station to the user equipment, timing information indicating a timing at which the paging occurs.

### Supplementary Note 9

The communication control method described in any one of supplementary note 1 to supplementary note 8 further including, at the user equipment, resetting the changed slice priority of the network slice to the slice priority before the change after executing the slice specific cell reselection procedure.

### Supplementary Note 10

The communication control method described in any one of supplementary note 1 to supplementary note 9, further including, at the user equipment, resetting the changed frequency priority of the frequency that supports the network slice to the frequency priority before the change after executing the slice specific cell reselection procedure.

### Supplementary Note 11

A communication control method in a mobile communication system, the communication control method including:
transmitting, by a user equipment to a core network device, MT slice information indicating a network slice associated with paging, and timing information indicating a timing at which the paging occurs; and
transmitting, by the user equipment, to a base station, MT slice support frequency information indicating a frequency that supports the network slice, and the timing information.

### REFERENCE SIGNS

1: Mobile communication system
20: CN
100: UE
110: Receiver
120: Transmitter
130: Controller
200: gNB
210: Transmitter
220: Receiver
230: Controller
300: AMF

1. A communication control method in a mobile communication system, the communication control method comprising:
transmitting, by a core network node to a user equipment, Mobile Terminated (MT) slice information indicating a network slice associated with paging.

2. The communication control method according to claim 1, further comprising:
at a radio access network node, transmitting a paging message to the user equipment;
at the user equipment, changing a slice priority of the network slice based on the MT slice information; and
at the user equipment, executing a slice specific cell reselection procedure according to the changed slice priority.

3. The communication control method according to claim 1,
wherein the transmitting the MT slice information to the user equipment comprises transmitting, by the core network node to the user equipment, first change indication information indicating change of a slice priority of the network slice.

4. The communication control method according to claim 1, further comprising:
transmitting, by a radio access network node to the user equipment, MT slice support frequency information indicating a frequency that supports the network slice.

5. The communication control method according to claim 4, further comprising:
at the user equipment, changing a frequency priority of the frequency that supports the network slice based on the MT slice support frequency information; and
at the user equipment, executing a slice specific cell reselection procedure according to the changed frequency priority.

6. The communication control method according to claim 4,
wherein the transmitting the MT slice support frequency information to the user equipment comprises transmitting, by the radio access network node to the user equipment, second change indication information comprising information indicating change of a frequency priority of the frequency that supports the network slice.

7. The communication control method according to claim 1,
wherein the transmitting the MT slice information to the user equipment comprises transmitting, by the core network node to the user equipment, timing information indicating a timing at which the paging occurs.

8. The communication control method according to claim 4,
wherein the transmitting the MT slice support frequency information to the user equipment comprises transmitting, by the radio access network node to the user equipment, timing information indicating a timing at which the paging occurs.

9. The communication control method according to claim 2, further comprising:
at the user equipment, resetting the changed slice priority of the network slice to the slice priority before the change after executing the slice specific cell reselection procedure.

10. The communication control method according to claim 5, further comprising:
at the user equipment, resetting the changed frequency priority of the frequency that supports the network slice to the frequency priority before the change after executing the slice specific cell reselection procedure.

11. A communication control method in a mobile communication system, the communication control method comprising:
transmitting, by a user equipment to a core network node, MT slice information indicating a network slice associated with paging, and timing information indicating a timing at which the paging occurs; and
transmitting, by the user equipment to a radio access network node, MT slice support frequency information indicating a frequency that supports the network slice, and the timing information.

12. A user equipment comprising:
a transmitter configured to transmit to a core network node, MT slice information and timing information, the MT slice information representing a network slice associated with paging, the timing information representing a timing at which the paging occurs,
wherein the transmitter configured to transmit to a radio access network node, the timing information and MT slice support frequency information representing a frequency that supports the network slice.
